(19) United States
(12) Patent Application Publication
(10) Pub. No.: US 2009/0145702 A1
(43) Pub. Date: Jun. 11, 2009

(54) Brake pad for a vehicle disc brake assembly

(75) Inventor: Charles Giacomazza, Plymouth, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: Kelsey-Hayes Company

(21) Appl. No.: 11/999,583

(22) Filed: Dec. 6, 2007

(51) Int. Cl. F16D 65/092; F16D 55/225

(52) U.S. Cl. 188/73.1; 188/250 B

(57) ABSTRACT

An improved structure for a brake pad adapted for use in a disc brake assembly. The brake pad includes a backing plate and a friction pad. The friction pad includes a lengthwise axis of symmetry. The brake pad is adapted to align a friction pad area centroid relative to a piston applied pressure centroid to reduce friction pad tangential taper wear. The force centroid axis and the area centroid axis further define an offset such that the offset diminishes during a braking event.

### BACKGROUND OF THE INVENTION

This invention relates in general to vehicle brake assemblies and in particular to an improved structure for a disc brake pad adapted for use in such a vehicle brake assembly.

Most vehicles are equipped with a brake system for slowing or stopping movement of the vehicle in a controlled manner. A typical brake system for an automobile or light truck includes a disc brake assembly for each of the front wheels and either a drum brake assembly or a disc brake assembly for each of the rear wheels. The brake assemblies are actuated by hydraulic or pneumatic pressure generated when an operator of the vehicle depresses a brake pedal. The structures of these drum brake assemblies and disc brake assemblies, as well as the actuators therefore, are well known in the art.

A typical disc brake assembly includes a rotor which is secured to the wheel of the vehicle for rotation therewith. A caliper assembly is slidably supported by pins secured to an anchor bracket. The anchor bracket is secured to a non-rotatable component of the vehicle, such as the steering knuckle or the vehicle frame. The caliper assembly includes a pair of brake pads, or brake shoes, which are disposed on opposite sides of the rotor. The brake pads are operatively connected to one or more hydraulically actuated pistons for movement between a non-braking position, wherein they are spaced apart from opposed axial sides or braking surfaces of the rotor, and a braking position, wherein they are moved into frictional engagement with the opposed braking surfaces of the rotor. When the operator of the vehicle depresses the brake pedal, the piston urges the brake pads from the non-braking position to the braking position so as to frictionally engage the opposed braking surfaces of the rotor and thereby slow or stop the rotation of the associated wheel of the vehicle.

### SUMMARY OF THE INVENTION

This invention relates to an improved structure for a brake pad adapted for use in a disc brake assembly. The brake pad includes a backing plate and a friction pad. The brake pad may further include a noise shim. The friction pad includes a lengthwise axis of symmetry and is further adapted to align a friction pad area centroid relative to a piston applied pressure centroid to reduce the pad contact area pressure differential and uneven friction pad wear.

Other advantages of this invention will become apparent to those skilled in the art from the following detailed description of the invention, when read in light of the accompanying drawings.

### BRIEF DESCRIPTION OF THE DRAWINGS

FIG. 1 is a perspective view of a portion of a prior art vehicle disc brake assembly.

FIG. 2 is an exploded perspective view of selected components of the prior art vehicle disc brake assembly illustrated in FIG. 1.

FIG. 3 is a sectional elevational view of a portion of the prior art disc brake assembly illustrated in FIG. 1.

FIGS. 4A and 4B are perspective views of prior art shifted geometry disc brake pads.

FIG. 5 is a perspective view of a disc brake caliper including a first embodiment of a disc brake pad of the invention.

FIG. 6 is a perspective view of a second embodiment of a disc brake pad of the invention.

FIG. 7 is a side elevational view of a third embodiment of a disc brake pad of the invention.

### DETAILED DESCRIPTION OF THE PREFERRED EMBODIMENTS

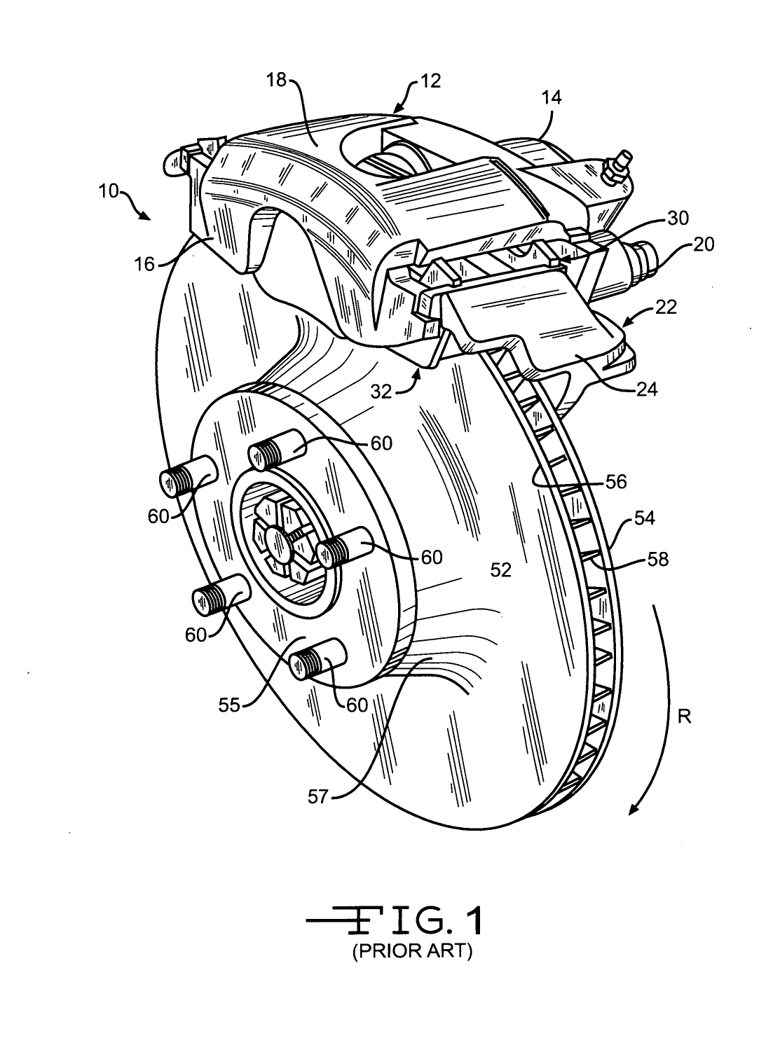

Referring now to the drawings, there is illustrated in prior art FIGS. 1 through 3 a portion of a prior art vehicle disc brake assembly, indicated generally at 10, and as will be discussed below, is associated with a right side mounted wheel of a vehicle. The general structure and operation of the prior art disc brake assembly 10 is conventional in the art. Thus, only those portions of the prior art disc brake assembly 10 which are necessary for a full understanding of this invention will be explained and illustrated.

The prior art disc brake assembly 10 is a sliding type of disc brake assembly and includes a generally C-shaped caliper, indicated generally at 12. The caliper 12 includes an inboard leg portion 14 and an outboard leg portion 16 which are interconnected by an intermediate bridge portion 18. The caliper 12 is slidably supported on a pair of pins 20 secured to an anchor bracket, indicated generally at 22. The anchor bracket 22 is, in turn, secured to a stationary component of the vehicle. Such a stationary component can be, for example, an axle flange (not shown), when the disc brake assembly 10 is installed for use on the rear of the vehicle, or a steering knuckle (not shown), when the disc brake assembly 10 is installed for use on the front of the vehicle.

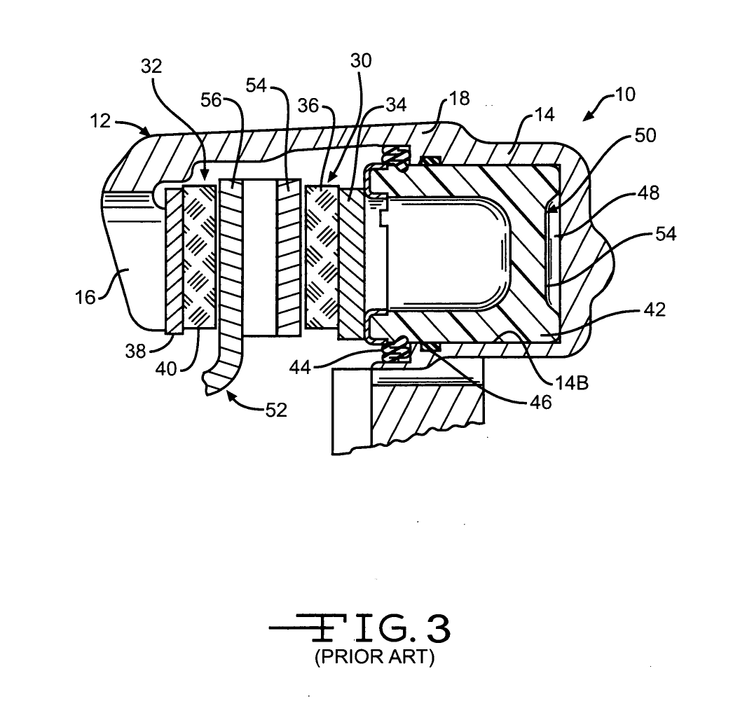

The pins 20 extend through non-threaded apertures 14A formed in the inboard leg 14 of the caliper 12. The pins 20 have respective threaded ends 20A which are received in threaded apertures 22A provided in anchor bracket 22. The pins 20 support the caliper 12 for sliding movement relative to the anchor bracket 22 in both the outboard direction (left when viewing prior art FIG. 3) and the inboard direction (right when viewing prior art FIG. 3). Such sliding movement of the caliper 12 occurs when the disc brake assembly 10 is actuated, as will be explained below. A pair of bolts (not shown) extend through a pair of non-threaded apertures 22B formed in the anchor bracket 22 to secure the anchor bracket 22 to the stationary vehicle component. Alternatively, other known securing methods can be used to secure the anchor bracket 22 to the stationary vehicle component and/or the caliper 12 to the anchor bracket 22.

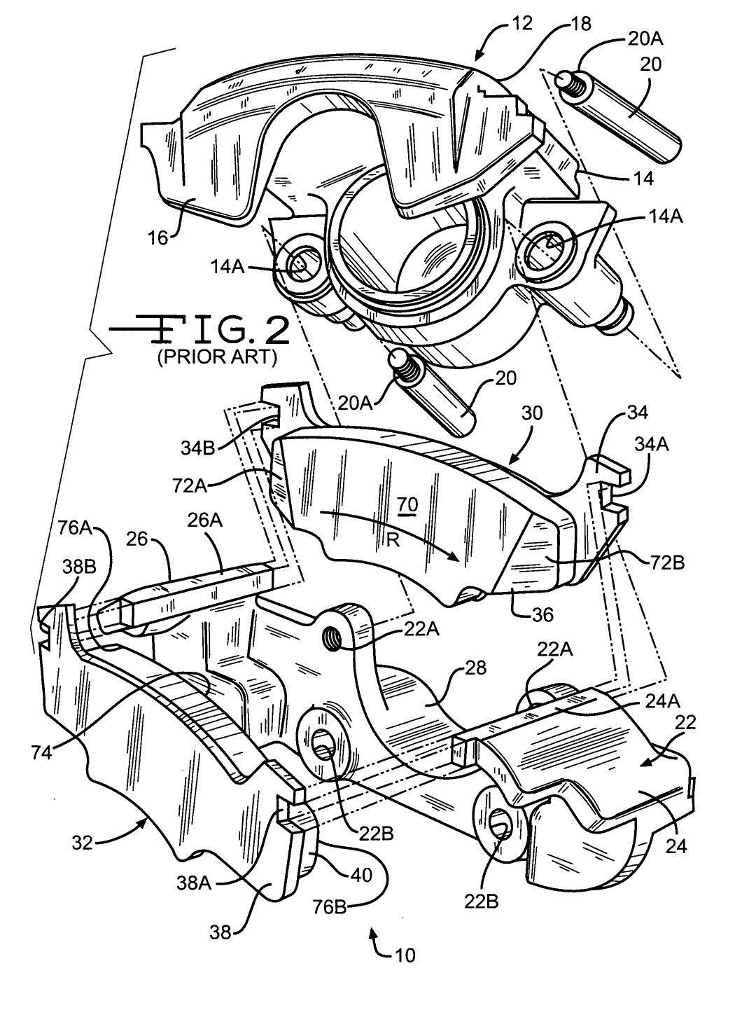

As best shown in prior art FIG. 2, the anchor bracket 22 includes a pair of axially and outwardly extending arms 24 and 26 which are interconnected at their inboard ends by an inner tie bar 28. The arms 24 and 26 have upstanding guide rails 24A and 26A, respectively formed thereon. The guide rails 24A and 26A extend transverse to the arms 24 and 26, respectively, and parallel to one another. The guide rails 24A and 26A slidably support an inboard brake pad, indicated generally at 30, and an outboard brake pad, indicated generally at 32, respectively.

The inboard brake pad 30 includes a backing plate 34 and a friction pad 36. The inboard backing plate 34 includes opposed ends having notches 34A and 34B formed therein, for supporting the inboard brake pad 30 on the guide rails 24A and 26A of the anchor bracket 22. The inboard brake pad 30 further includes a friction pad contact area 70 having a leading end 72A and a trailing end 72B. The outboard brake pad 32 includes a backing plate 38 and a friction pad 40. The outboard backing plate 38 includes opposed ends having notches 38A and 38B formed therein, for supporting the outboard brake pad 32 on the guide rails 24A and 26A of the anchor bracket 22. The outboard brake pad 32 further includes a friction pad contact area 74 having a leading end 76A and a trailing end 76B. Alternatively, the inboard brake pad 30 can be supported on a brake piston of the prior art disc brake assembly 10, while the outboard brake pad 32 can be supported on the outboard leg portion 16 of the caliper 12.

An actuator, indicated generally at 50 in prior art FIG. 3, is provided for effecting the operation of the disc brake assembly 10. The actuator 50 includes a brake piston 42 which is disposed in a counterbore or recess 14B formed in the outboard surface of the inboard leg 14 of the caliper 12. The actuator 50, shown in this embodiment as being a hydraulically powered actuator, is operable to move the piston 42 within the recess 14B in the outboard direction (left when viewing prior art FIG. 3). However, other types of actuators 50, such as for example, electrical, pneumatic, and mechanical types, can be used if so desired.

The prior art disc brake assembly 10, as best shown in prior art FIG. 3, also includes a dust boot seal 44 and an annular fluid seal 46. The dust boot seal 44 is formed from a flexible material and has a first end which engages an outboard end of the recess 14B. A second end of the dust boot seal 44 engages an annular groove formed in an outer side wall of the piston 42. A plurality of flexible convolutions are provided in the dust boot seal 44 between the first and second ends thereof. The dust boot seal 44 is provided to prevent water, dirt, and other contaminants from entering into the recess 14B. The fluid seal 46 is disposed in an annular groove formed in a side wall of the recess 14B and engages the outer side wall of the piston 42. The fluid seal 46 is provided to define a sealed hydraulic actuator chamber 48, within which the piston 42 is disposed for sliding movement. Also, the fluid seal 46 is designed to function as a “roll back” seal to retract the piston 42 within the recess 14B (right when viewing prior art FIG. 3) when the brake pedal is released.

The prior art disc brake assembly 10, shown in FIGS. 1 and 3, further includes a brake rotor 52, which is connected to a wheel (not shown) of the vehicle for rotation therewith via a hub (not shown). The illustrated brake rotor 52 includes a pair of opposed friction discs 54 and 56 which are spaced apart from one another by a plurality of intermediate fins or posts 58 in a known manner. The brake rotor 52 extends radially outwardly between the inboard friction pad 36 and the outboard friction pad 40. The brake rotor 52 further includes a mounting flange 55 and a hat section 57.

When it is desired to actuate the prior art disc brake assembly 10 to retard or stop the rotation of the brake rotor 52 and the vehicle wheel associated therewith, (which when associated with a right side mounted wheel of the vehicle is rotating in a clockwise direction indicated by an arrow R shown in prior art FIG. 1), the driver of the vehicle depresses the brake pedal (not shown). In a manner which is well known in the art, the depression of the brake pedal causes pressurized hydraulic fluid to be introduced into the chamber 48. Such pressurized hydraulic fluid urges the piston 42 in the outboard direction (toward the left when viewing prior art FIG. 3) into engagement with the backing plate 34 of the inboard brake pad 30. As a result, the friction pad 36 of the inboard brake pad 30 is moved into frictional engagement with the inboard friction disc 54 of the brake rotor 52. At the same time, the caliper 12 slides on the pins 20 in the inboard direction (toward the right when viewing prior art FIG. 3) such that the outboard leg 16 thereof moves the friction pad 40 of the outboard brake pad 32 into frictional engagement with the outboard friction disc 56 of the brake rotor 52. The leading ends 72A and 76A of the friction pads 36 and 40, respectively, are the first portions of the friction pad contact areas 70 and 72 of the brake pads 30 and 32, respectively, to engage the brake rotor 52. The trailing ends 72B and 76B of the friction pads 36 and 40, respectively, are the last portions of the friction pad contact areas 70 and 72 of the brake pads 30 and 32, respectively, to engage the brake rotor 52. As a result, the opposed friction discs 54 and 56 of the brake rotor 52 are frictionally engaged by the respective friction pads 36 and 40 to slow or stop relative rotational movement thereof.

When the brake pads 30 and 32 engage the brake rotor 52, the prior art disc brake assembly 10 and the related mounting and wheel end components (not shown) deflect under the applied braking forces. Depending on the relative stiffnesses of these mounting and wheel end components such as, for example, rotor and hub assemblies, steering knuckles, and caliper mounting brackets, the reactive deflections may cause the applied force of the friction pad 36 of the brake pad 30 to be shifted relative to the force applied by the piston 42 against the backing plate 34 of the brake pad 30.

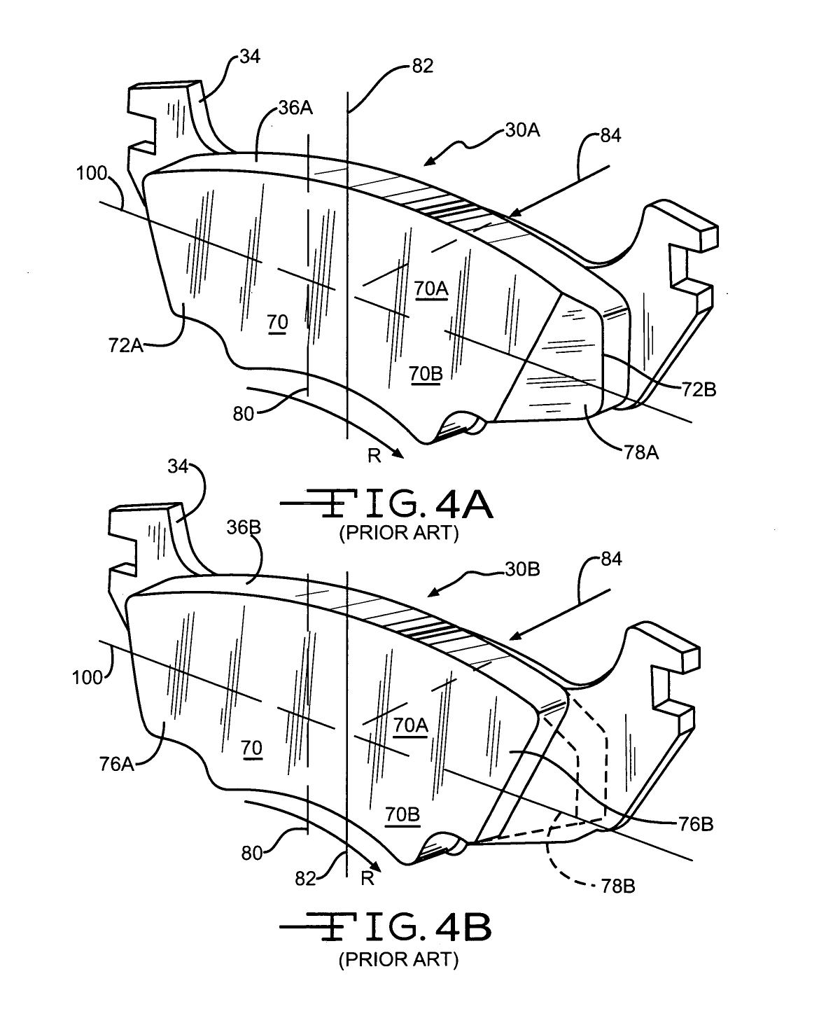

As shown in prior art FIGS. 4A and 4B, the friction pad applied force described above generally acts along a friction pad area centroid 80 while a piston applied force 84 acts along a piston force centroid 82. The shift in the friction pad area centroid 80 relative to the piston applied force 84, and thus the piston force centroid 82, may result in tangential taper wear, or uneven wear, of the friction pad 36 of the brake pad 30 which may contribute to reduced brake pad life. In addition to the piston applied force 84, the contact of the friction pad contact area 70 to the rotor 52 produces a self-energizing effect that further shifts the piston force centroid 82 and the friction pad area centroid 80 away from each other. As such, the resulting stress profile of the friction pad contact area 70 may be more heavily loaded away from the piston force centroid 82 and toward either the leading end 72A or the trailing end 72B thereof.

The piston 42 is typically oriented at the center of the backing plate 34 of the inboard pad 30. The piston 42, however, may be altered in size or shifted lengthwise relative to the backing plate 34 in order to realign the piston applied and friction pad applied forces, thus compensating for the reactive component deflections. Shifting the piston location or providing multiple sized pistons, however, may require a large array of custom caliper designs, thus adding more cost and complexity for brake manufacturers. Therefore, it is known to incorporate force shifting features in the brake pads 30 and 32 to allow for more standardized caliper and piston designs.

Referring now to prior art FIG. 4A and using like reference numbers to indicate corresponding parts, there is illustrated a prior art disc brake pad 30A having a modification to the geometry of the friction pad 36A, in the form of a single chamfer 78A. The chamfer 78A is provided to compensate for reactive deflections and thus realign the area centroid 80 of the contact area 70 of the friction pad 36A relative to the force centroid 82 of the piston applied force 84 during operation. FIG. 4A illustrates the chamfer 78A applied to the trailing end 72B of the inboard pad 30A of a right-side mounted, disc brake assembly 10. Though discussed and illustrated relative to the inboard pad 30A, a similar modification is also known to be applied to the outboard pad, such as the outboard pad 32 of FIG. 2. Additionally, the chamfer 78A is known to be applied to either the leading end 72A or the trailing end 72B of the brake pad 30A, or the outboard pad (not shown), depending on specific vehicle requirements.

The disc brake pad 30A is shown relative to a lengthwise oriented or longitudinal axis 100. As used throughout the descriptions of the prior art brake pads and the various brake pad embodiments disclosed herein, the term lengthwise axis defines an axis oriented in the direction of length, where the length dimension is longer than the orthogonally oriented width and thickness dimensions. The lengthwise axis 100 is further oriented in a substantially tangential position relative the rotational direction R of the rotor 52. The lengthwise axis 100 bisects the brake pad 30A, as well as the friction pad 36A into upper and lower halves 70A and 70B, respectively. The upper half 70A and the lower half 70B are not geometrically symmetrical about the lengthwise axis 100. Because the prior art inboard brake pad 30A, along with the friction pad 36A, lacks symmetry about the lengthwise axis 100 unique designs for right-hand and left-hand applications are required.

Referring now to prior art FIG. 4B and using like reference numbers to indicate corresponding parts, there is illustrated a prior art disc brake pad 30B having a modification to the geometry of the friction pad 36B, in the form of a notch or void 78B. The void 78B is illustrated in FIG. 4B as a phantom area of material removed from the trailing end 76B of a full length friction pad. The void 78B is provided to compensate for reactive deflections and thus realign the area centroid 80 of the contact area 70 of the friction pad 36B relative to the force centroid 82 of the piston applied force 84 during operation. FIG. 4B illustrates the void 78B applied to the trailing end 76B of the inboard pad 30B of a right-side mounted, disc brake assembly 10. Though discussed and illustrated relative to the inboard pad 30B, a similar modification is also known to be applied to the outboard pad, such as the outboard pad 32 of FIG. 2. Additionally, the void 78B is known to be applied to either the leading end 76A or the trailing end 76B of the inboard brake pad 30B, or the outboard pad (not shown), depending on specific vehicle requirements. The disc brake pad 30B is shown relative to a lengthwise oriented or longitudinal axis 100. The lengthwise axis 100 is oriented in a substantially tangential position relative the rotational direction R of the rotor 52. The longitudinal axis 100 bisects the brake pad 30B, as well as the friction pad 36B into upper and lower halves 70A and 70B, respectively. The upper half 70A and the lower half 70B are not geometrically symmetrical about the lengthwise axis 100. Because the prior art inboard brake pad 30B, along with the friction pad 36B, lacks symmetry about the lengthwise axis 100 unique designs for right-hand and left-hand applications are required. The structure and operation of the prior art disc brake assembly 10 and associated components thereof and the prior art pads 30A and 30B thus far described are conventional in the art.

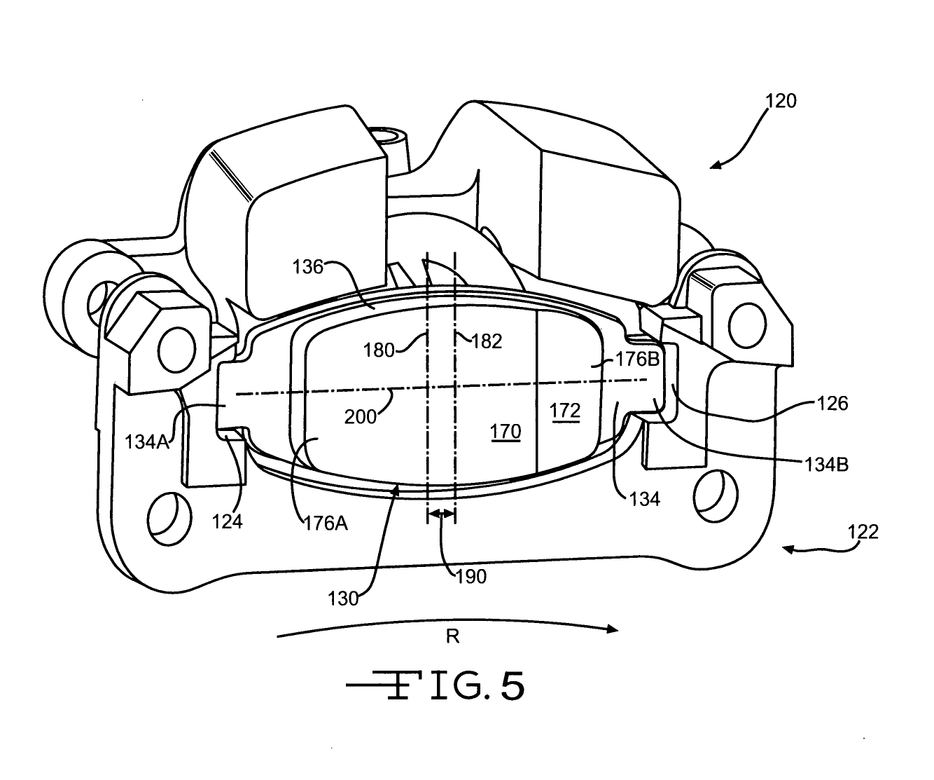

Referring now to FIG. 5, there is illustrated a portion of a brake caliper, indicated generally at 120, which is associated with a right side mounted wheel of a vehicle, and which includes a first embodiment of a brake pad, indicated generally at 130. In the illustrated embodiment, the brake pad 130 includes a friction pad 136 that is preferably substantially symmetrical about a lengthwise or longitudinal axis of symmetry 200. The longitudinal axis of symmetry 200 is substantially tangent to the rotor rotational direction R. The friction pad 136 includes a friction contact area 170 having an upper half 170A and a lower half 170B. The upper half 170A and the lower half 170B of the friction pad contact area 170 are symmetrical about the lengthwise axis of symmetry 200. The friction pad 136 further includes a leading end 176A and a trailing end 176B. In the illustrated embodiment, the trailing end 176B includes a chamfer 172, which may also be symmetrical about the lengthwise axis of symmetry 200. In the illustrated embodiment, the brake pad 130 further includes a symmetrical backing plate 134 that is also illustrated as being substantially symmetrical about the longitudinal axis of symmetry 200.

FIG. 5 further shows a piston force centroid axis 182 and a friction pad area centroid axis 180 that are preferably substantially perpendicular to the longitudinal axis of symmetry 200, though such is not required. The distance between the piston force centroid axis 182 and the friction pad area centroid axis 180 defines an offset 190. The offset 190 represents the relative displacement of the friction pad area centroid axis 180 to the piston force centroid axis 182 prior to any deflected state of the wheel end related components due to braking force reactions. The offset 190 may be a function for example of the pad friction material, its coefficient of friction and thickness, the backing plate frictional properties, and the relative location of the area contact centroid 180 to the portion of the backing plate 134 at the brake pad trailing end 176B, along with other possible structural factors.

In the illustrated embodiment, the backing plate 134 includes a pair of opposed, outwardly projecting tabs 134A and 134B. The outwardly projecting tabs 134A and 134B are also symmetrical about the longitudinal axis of symmetry 200. The tabs 134A and 134B are engaged into complementary guide slots 124 and 126, respectively, that are part of an anchor bracket 122. Alternatively, the construction of the backing plate 134 may be other than illustrated if so desired. For example, the shape of the backing plate 134 may be other than illustrated; one or both of the tabs 134A and 134B may be nonsymmetrical. Furthermore, the guide slots 124 and 126 may be guide rails, similar in shape to the prior art guide rails 24A and 26A shown in FIG. 2, and preferably lie substantially along the longitudinal axis of symmetry 200. The friction pad 136 may be attached to the backing plate 134 by any suitable method, such as for example molding, bonding, riveting, upset forming, crimping, and the like.

When a braking event occurs, the brake pads are pressed into frictional engagement with the rotor as described above. The wheel end related components may deflect in a reaction that is proportional, in part, to these braking generated forces. The offset 190 is sized such that as greater braking generated forces are applied the offset 190 is diminished. The offset 190 may be selected to reach a zero point at a design brake load, such that the friction pad area centroid axis 180 is substantially coincident with the piston force centroid axis 182. The resulting effect is a minimization of tangential taper wear of the friction pad contact area 170, which may provide improved brake pad life. The brake pad 130 may include the chamfer 172 at the trailing end 176B in order to create the offset 190. Furthermore, the chamfer 172 may be applied to the leading end 176A of the friction pad 136 in order to effect the offset 190 in the opposite direction. Alternatively, the construction of the brake pad 130 may be other than illustrated if so desired. For example, instead of the chamfer 172, the trailing end 176B or the leading end 176A of the brake pad 130 may be provided with a notch or void, similar to the void 78B shown in connection with the prior art brake pad 30B in FIG. 4B.

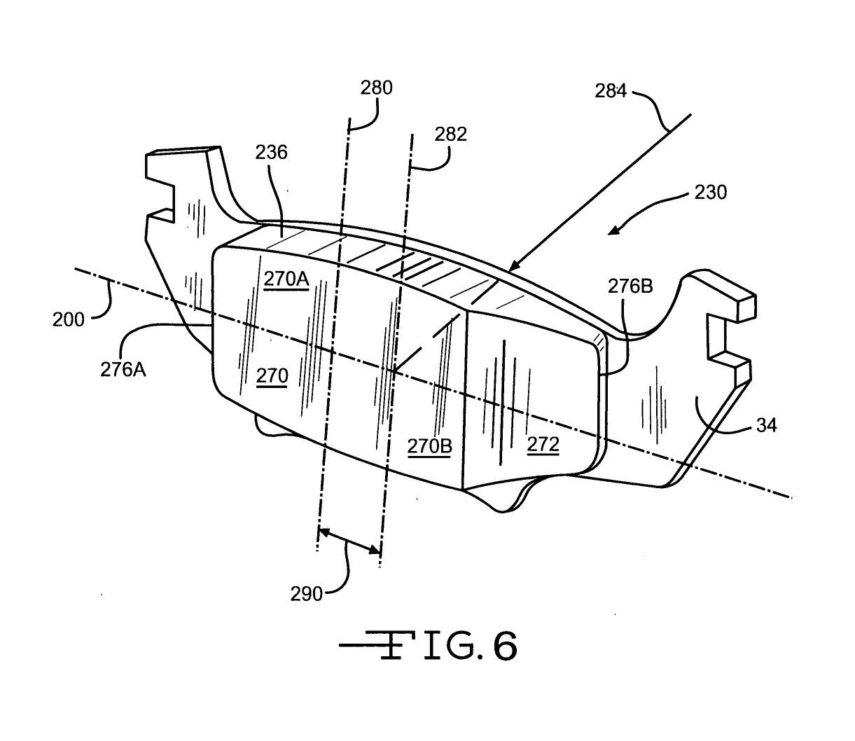

Referring now to FIG. 6 and using like reference numbers to indicate corresponding parts, there is illustrated a second embodiment of a brake pad, indicated generally at 230. In this embodiment, a longitudinally symmetrical friction pad 236 includes a friction pad contact area 270 having the longitudinal axis of symmetry 200. The longitudinal axis of symmetry 200 bisects the friction pad 236 into upper and lower halves 270A and 270B, respectively. The upper half 270A and the lower half 270B of the friction pad 236 are substantially geometrically symmetrical about the longitudinal axis of symmetry 200. The longitudinally symmetrical friction pad 236 is attached to the backing plate 34. The friction pad 236 may be attached to the backing plate 34 by any suitable method, such as for example molding, bonding, riveting, upset forming, crimping, and the like.

As shown in FIG. 6, in this embodiment the longitudinally symmetrical friction pad 236 may be oriented with a chamfer 272 (or a void (not shown) similar to the void 78B in FIG. 4B) positioned as required affect the proper realignment of a piston force centroid axis 282 and a friction pad area centroid axis 280 during the braking event or brake force application as described above. When a braking event occurs, the brake pads are pressed into frictional engagement with the rotor as described above. The wheel end related components may deflect in a reaction that is proportional, in part, to these braking generated forces. The offset 290 is sized such that as greater braking generated forces are applied the offset 290 is diminished. The offset 290 may be selected to reach a zero point at a design brake load, such that the friction pad area centroid axis 280 is substantially coincident with the piston force centroid axis 282. The resulting effect is a minimization of tangential taper wear of the friction pad contact area 270, which may provide improved brake pad life. Alternatively, the construction of the brake pad 230 may be other than illustrated if so desired. For example, the orientation of the chamfer 272, or void (not shown), may be located at a trailing end 276B or a leading end 276A, as so desired, by reversing the orientation of the friction pad 236 relative to the backing plate 34 during manufacture.

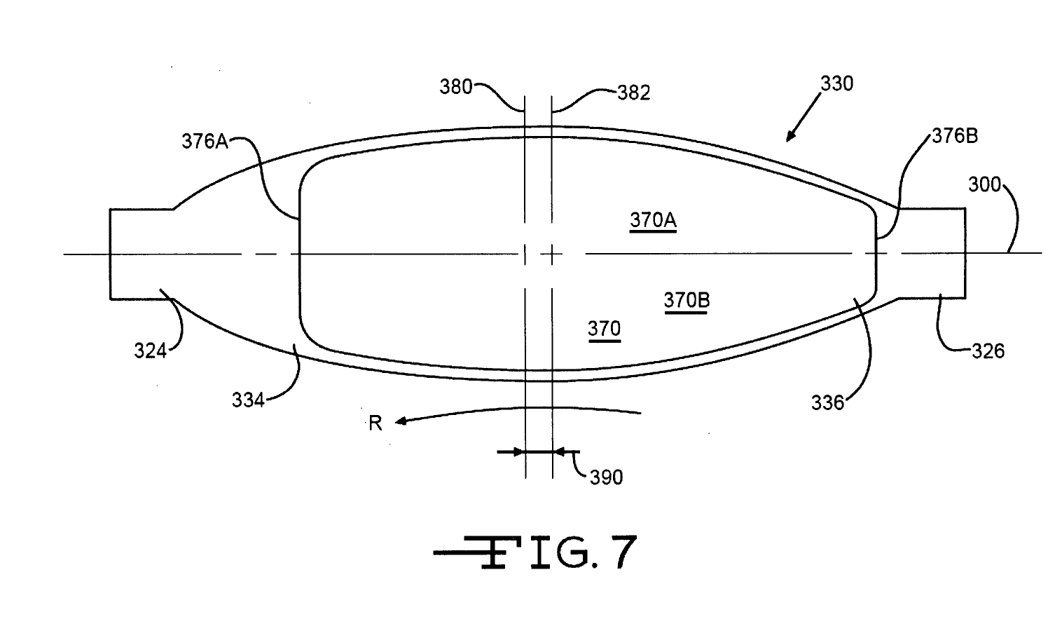

Referring now to FIG. 7 and using like reference numbers to indicate corresponding parts, there is illustrated a third embodiment of a brake pad, indicated generally at 330, which is associated with a right side mounted wheel and disc brake system (not shown). In this embodiment, the longitudinally symmetrical brake pad 330 includes a backing plate 334 and a friction pad 336. The friction pad 336 includes a friction pad contact area 370 that is substantially continuous over the length of the friction pad 336 and along a longitudinal axis of symmetry 300. In this embodiment, the longitudinal axis of symmetry 300 bisects the friction pad 336 into an upper half 370A and a lower half 370B. The upper half 370A and the lower half 370B are substantially geometrically symmetrical about the longitudinal axis of symmetry 300. FIG. 7 further shows the backing plate 334 as being substantially symmetrical about the longitudinal axis of symmetry 300, though such is not required. The friction pad 336 may be attached to the backing plate 334 by any suitable method, such as for example molding, bonding, riveting, upset forming, crimping, and the like.

A piston force centroid axis 382 is illustrated as being located in the substantially linear center of the brake pad 330. The friction pad area centroid is represented by an area centroid axis 380 where the frictional pad surface area is substantially equal on both sides of the area centroid axis 380. Though each of these surface areas may have substantially equal numerical values, the different geometric configurations cause the area centroid axis 380 to be shifted appropriately along the longitudinal axis of symmetry 300. In the illustrated embodiment of FIG. 7, the friction pad 336 is depicted as having a longer, more tapered geometry oriented toward a trailing end 376B, though such is not required. The more tapered geometry may alternatively be oriented toward a leading end 376A, if so desired. The shift of the piston force centroid axis 382 relative to the area centroid axis 380 defines an offset 390. During a braking event, the offset 390 is sized such that deflections of the related wheel end and mounting components (not shown) facilitates realignment of the area centroid axis 380 toward the piston force centroid axis 382. This axis realignment, occurring when the braking forces are generated, diminishes the offset 390 in a relationship that is substantially proportional, in part, to the generated braking forces.

The friction pad 336, shown in FIG. 7, may be applied to the prior art backing plate 34 in a similar manner to the brake pad 230 depicted in FIG. 6, if so desired. When applied to the backing plate 34, the symmetrical friction pad 336 may be oriented with the elongated section, shown at the trailing edge 376B, positioned as required to affect the proper realignment of the piston force centroid axis 382 and the contact area centroid axis 380. In operation, the brake pad embodiment shown in FIG. 7 also functions in a similar manner to the embodiment shown in FIG. 5 and described above.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A brake pad adapted for use in a disc brake assembly comprising:
a backing plate; and
a friction pad having a lengthwise axis defining a line of symmetry, the friction pad further including a friction pad contact area having an upper half and a lower half, wherein the upper half and the lower half are symmetrical about the lengthwise axis.

2. The brake pad of claim 1 wherein the friction pad includes an area centroid axis and the backing plate includes a force centroid axis, the force centroid axis and the area centroid axis defining an offset.

3. The brake pad of claim 1 wherein the backing plate is nonsymmetrical about the lengthwise axis.

4. The brake pad of claim 3 wherein the friction pad includes a chamfered end.

5. The brake pad of claim 3 wherein the friction pad includes a notched end.

6. The brake pad of claim 3 wherein the friction pad includes a first area and a second area separated by the area centroid axis, the first area having an elongated geometry relative to the second area.

7. The brake pad of claim 1 wherein the backing plate is symmetrical about the lengthwise axis.

8. The brake pad of claim 7 wherein the friction pad includes a chamfered end.

9. The brake pad of claim 7 wherein the friction pad includes a notched end.

10. The brake pad of claim 7 wherein the friction pad includes a first area and a second area separated by the area centroid axis, the first area having an elongated geometry relative to the second area.

11. A brake pad adapted for use in a disc brake assembly, the brake pad having a backing plate and a friction pad, the brake pad further having a lengthwise axis defining an axis of symmetry wherein the friction pad includes a friction pad contact area having an upper half and a lower half, the upper half and the lower half are symmetrical about the lengthwise axis, the friction pad and the backing plate are further symmetrical about the lengthwise axis, the friction pad further having an area centroid axis and the backing plate having a force centroid axis wherein the force centroid axis and the area centroid axis define an offset such that the offset diminishes during a braking event.

12. The brake pad of claim 11 wherein the backing plate includes a pair of opposed tabs.

13. The brake pad of claim 11 wherein the backing plate includes a pair of opposed recesses.

14. The brake pad of claim 11 wherein the friction pad includes a chamfered end.

15. The brake pad of claim 11 wherein the friction pad includes a notched end.

16. The brake pad of claim 11 wherein the friction pad includes a first area and a second area separated by the area centroid axis, the first area having an elongated geometry relative to the second area.

17. A disc brake assembly comprising:
a brake rotor;
a brake caliper;
a pair of brake pads carried by the disc brake assembly and adapted to be disposed on opposite axial sides of the brake rotor; and
an actuator for selectively moving the brake pads into frictional engagement with the brake rotor;
wherein at least one of the brake pads has a backing plate and a friction pad, the friction pad having a lengthwise axis defining a line of symmetry, the friction pad further including a friction pad contact area having an upper half and a lower half, wherein the upper half and the lower half are symmetrical about the lengthwise axis.

18. The disc brake assembly of claim 17 wherein the backing plate is symmetrical about the lengthwise axis, the backing plate including opposed ends having tabs formed thereon.

19. The disc brake assembly of claim 18 wherein the brake caliper includes a pair of pad guide slots along the lengthwise axis.

20. The disc brake assembly of claim 17 wherein the brake caliper includes a pair of pad guide rails along the lengthwise axis.
